(19) United States
(12) Patent Application Publication
(10) Pub. No.: US 2021/0103316 A1
(43) Pub. Date: Apr. 8, 2021

(54) LAPTOP SCREEN ELEVATOR SYSTEM

(71) Applicant: Kate Haffner, Warren, RI (US)

(72) Inventor: Kate Haffner, Warren, RI (US)

(21) Appl. No.: 17/039,825

(22) Filed: Sep. 30, 2020

Related U.S. Application Data
(60) Provisional application No. 62/909,884, filed on Oct. 3, 2019.

(51) Int. Cl. G06F 1/16; F16M 11/04; F16M 13/00

(52) U.S. Cl. CPC G06F 1/1679; G06F 1/1681; F16M 13/005; F16M 11/046; G06F 1/1656

(57) ABSTRACT

A laptop screen elevator system includes a mechanism for joining a laptop screen assembly to a laptop chassis. A hinge is attached to the laptop chassis, and a cantilever is attached to the hinge. A screen mount rides upon the cantilever by means of a slot. This screen mount attaches to and supports the screen. One or more buttons disposed within the screen mount may be pressed to release the screen mount from the cantilever, enabling a user to manually elevate or lower the screen relative to the laptop chassis.

### CROSS-REFERENCE TO RELATED APPLICATION(S)

The present application is related to and claims priority to U.S. Provisional Patent Application No. 62/909,884 filed Oct. 3, 2019, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of digital devices of existing art and more specifically relates to portable computers.

### RELATED ART

Using a laptop computer can lead to users assuming unnatural positions which the human body is not structurally suited for. Where there is a restriction in the space used to focus, the body collapses on itself anterioraly and in a hunched position. The shoulders roll in which causes strain on the neck muscles, mid to lower back muscles, and muscles that run along the spine. Also affected are the muscles in the front of the body being passively shortened from the anterior rotation or hunched position. In short, using laptop computers, especially when the laptop is situated on the user's lap, can lead to long term soreness or even injury. A suitable solution which improves the ergonomic use of a laptop is desired.

U.S. Pat. No. 7,724,511 to Matthew B. Jacobs relates to an adjustable display screen for a laptop computer. The described adjustable display screen for a laptop computer includes a laptop computer display screen which is adjustable to a user's convenience by constructing an adjustable angle instead of rigidly connecting the display screen to an extender mechanism via which the screen is vertically extended upwards away from the laptop body. An adjustable angle between the extended display screen and the extender mechanism may be established via a tilt-hinge, making the angle between the display screen and the extender mechanism easily adjustable by a user.

### SUMMARY OF THE INVENTION

In view of the foregoing disadvantages inherent in the known portable computer art, the present disclosure provides a novel laptop screen elevator. The general purpose of the present disclosure, which will be described subsequently in greater detail, is to provide a laptop screen elevator.

A laptop screen elevator system includes a mechanism for joining a laptop screen assembly to a laptop chassis. A hinge is attached to the laptop chassis, and a cantilever is attached to the hinge. A screen mount rides upon the cantilever by means of a slot. This screen mount attaches to and supports the screen. One or more buttons disposed within the screen mount may be pressed to release the screen mount from the cantilever, enabling a user to manually elevate or lower the screen relative to the laptop chassis.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a laptop screen elevator system, constructed and operative according to the teachings of the present disclosure.

FIG. 1 shows a laptop screen elevator during a lowered condition, according to an embodiment of the present disclosure.

FIG. 2 shows the laptop screen elevator of FIG. 1 during an elevated condition, according to an embodiment of the present disclosure.

FIG. 3 is a perspective view of the interaction between the cantilever and the screen-mount of the laptop screen elevator of FIG. 1, according to an embodiment of the present disclosure.

FIG. 4 is a perspective view of the laptop screen elevator of FIG. 1 during a lowered condition, according to an embodiment of the present disclosure.

FIG. 5 is a perspective view of the laptop screen elevator of FIG. 1 during an elevated condition, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a portable computer screen system and more particularly to a laptop screen elevator as used to improve the adjustability of a laptop screen relative to a laptop chassis.

The present invention provides users with the ability to selectively elevate and lower a laptop screen and set a desired screen height for a comfortable viewing position. Advantageously, such tailored adjustment can reduce strain in a user's head, neck, shoulders, and back, allowing a more natural and healthy posture while working on a laptop. In some embodiments, the device may also feature a push button and hydraulic components to enact raising and lowering of the laptop screen.

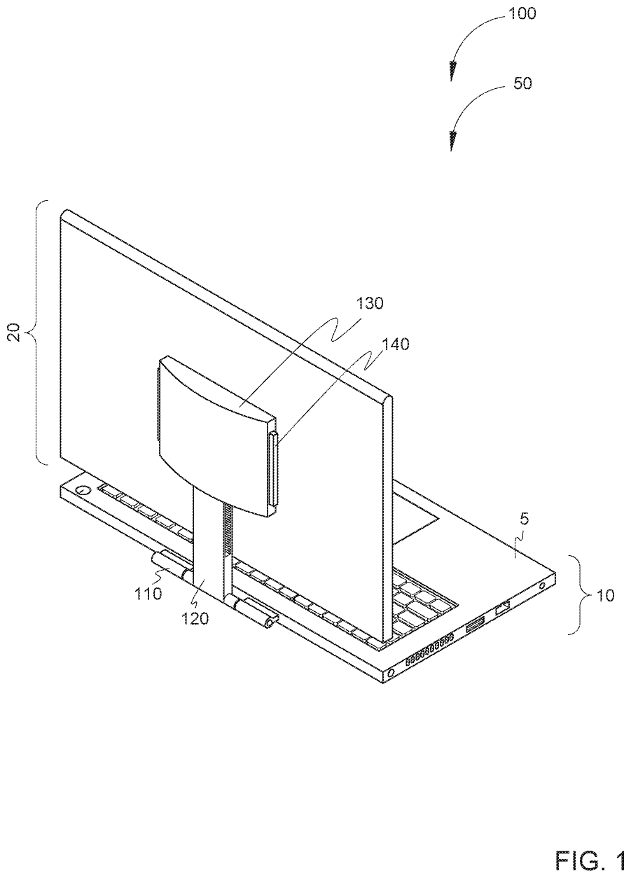

Referring now more specifically to the drawings by numerals of reference, there is shown in FIGS. 1-5, various views of a laptop screen elevator 100.

FIG. 1 shows a laptop screen elevator 100 during a lowered condition 50, according to an embodiment of the present disclosure. Here, the laptop screen elevator may be beneficial for use by a user to selectively elevate and lower a screen-assembly 20 of a laptop 5 relative to a laptop-chassis (or keyboard) 10 of the laptop 5. As illustrated, the laptop screen elevator 100 may include at least one hinge 110 pivotably connecting at least one cantilever 120 to laptop-chassis 10. At least one screen-mount 130 may connect screen-assembly 20 to at least one cantilever 120. At least one button 140 may be embedded within screen-mount 130. Pressing at least one button 140 may disengage screen-mount 130 from cantilever 120 such that a user may manually elevate or lower screen-assembly 20 relative to laptop-chassis 10, releasing button 140 when a desired elevation is reached. In the illustrated embodiment, at least one screen-mount 130 is a singular mount disposed somewhat centrally upon a backside of screen-assembly 20, and may be affixed to screen-assembly 20 by threaded fasteners or other means. In some embodiments, a quick-release fastener may be implemented.

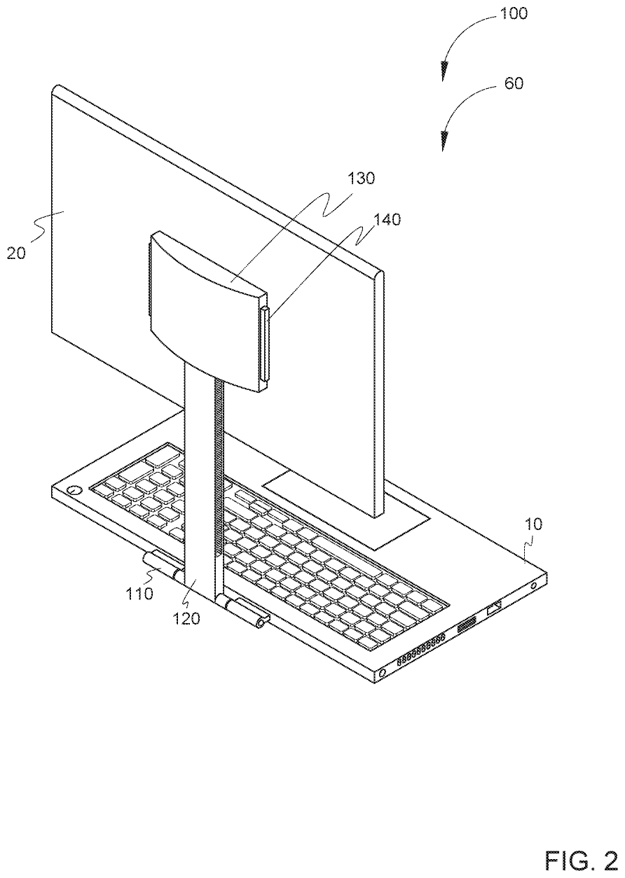

FIG. 2 shows the laptop screen elevator 100 of FIG. 1 during an elevated condition 60, according to an embodiment of the present disclosure. As shown, screen-assembly 20 may be elevated relative to laptop-chassis 10, such that cantilever 120 is exposed between screen-assembly 20 and laptop-chassis 10. As before, adjustment may be enacted by pressing button 140 and manually raising or lowering screen-mount 130. Hinge 110 may be rotated as desired by a user to angulate screen-assembly 20 relative to laptop-chassis 10.

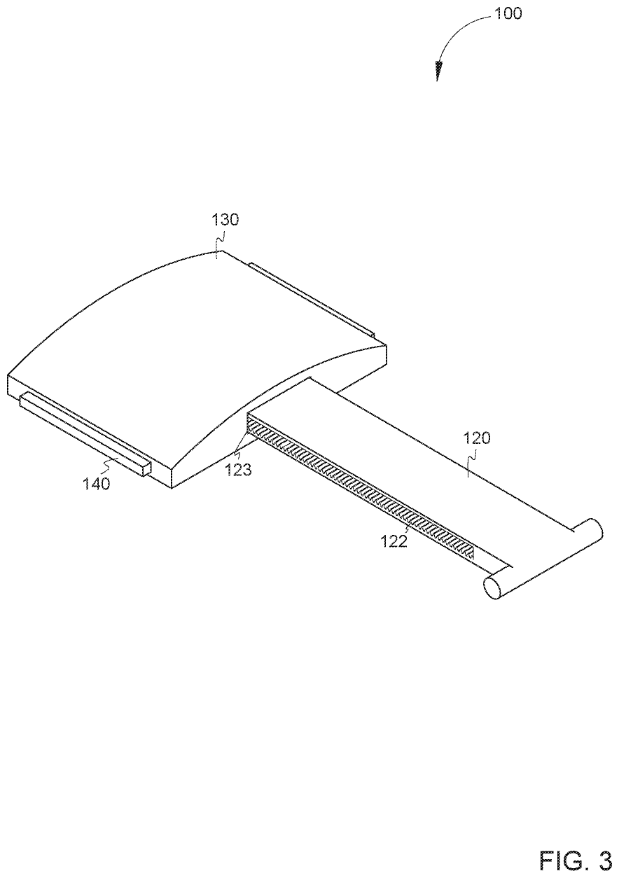

FIG. 3 is a perspective view of the interaction between the cantilever and the screen-mount of the laptop screen elevator 100 of FIG. 1, according to an embodiment of the present disclosure. As shown, cantilever 120 may include one or more of toothed-rack 122 which is able to engage with at least one button 140 when at least one button 140 is at rest. When button 140 is pressed, toothed-rack 122 is disengaged from screen-mount 130, thereby enabling cantilever 122 to slide within slot 123 which passes through screen-mount 130. In some embodiments, alternative methods of engagement may be implemented.

In a preferred embodiment, two buttons 140 and two toothed-racks 122 are provided within the single assembly. The two toothed-racks 122 may be disposed oppositely on cantilever 120 and face outwardly (left and right from a perspective looking towards the flat of the screen-assembly 20 (FIG. 1)). One each of buttons 140 are positioned to engage each toothed-rack 122, and also face opposingly and outwardly from screen-mount 130. In this way, additional strength is provided to the assembly and the screen-assembly 20 is unable to pitch left or right. To adjust the assembly, a user may pinch both buttons 140 with a thumb and forefinger. In some embodiments, at least one button 140 is spring-loaded.

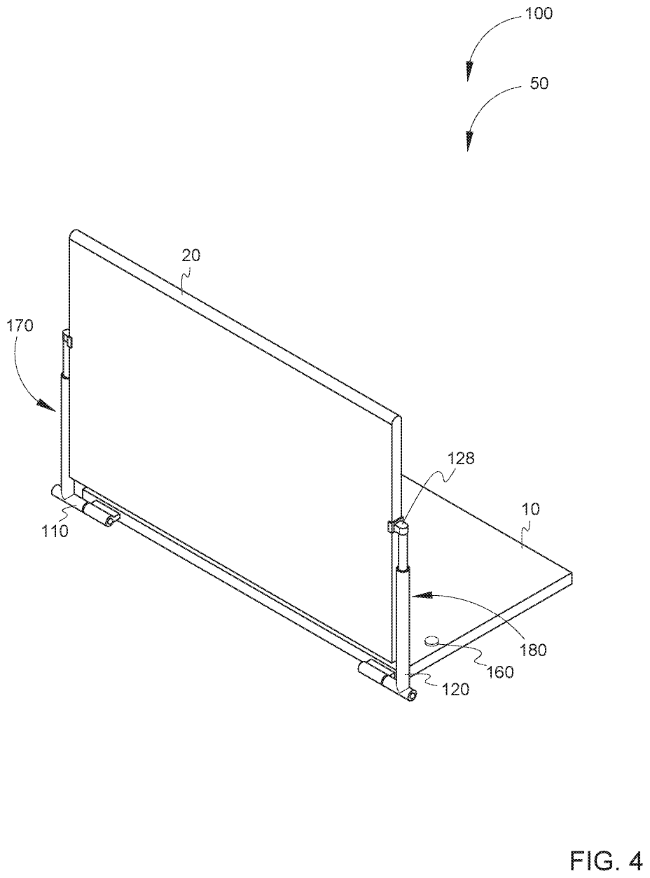

FIG. 4 is a perspective view of the laptop screen elevator 100 of FIG. 1 during a lowered condition 50, according to an embodiment of the present disclosure. In the illustrated embodiment, two cantilevers 120 and two screen-mounts 130 are provided; one left of the screen-assembly 20, and one right. Accordingly, at least one cantilever 120 may comprise right-cantilever 170 and left-cantilever 180 (left and right being determined from the perspective of a user viewing the screen). In the illustrated embodiment, laptop screen elevator 100 may further include a motor able to either elevate or de-elevate at least one screen-mount 130 relative to at least one hinge 110 by translating at least one cantilever 120 within the slot 123, and an activator 160 embedded into the laptop-chassis 10 able to either advance or retard the motor. Activator 160 may be an electrical button. Laptop screen elevator 100 may further comprising a linkage connecting the motor to the at least one screen-mount 130.

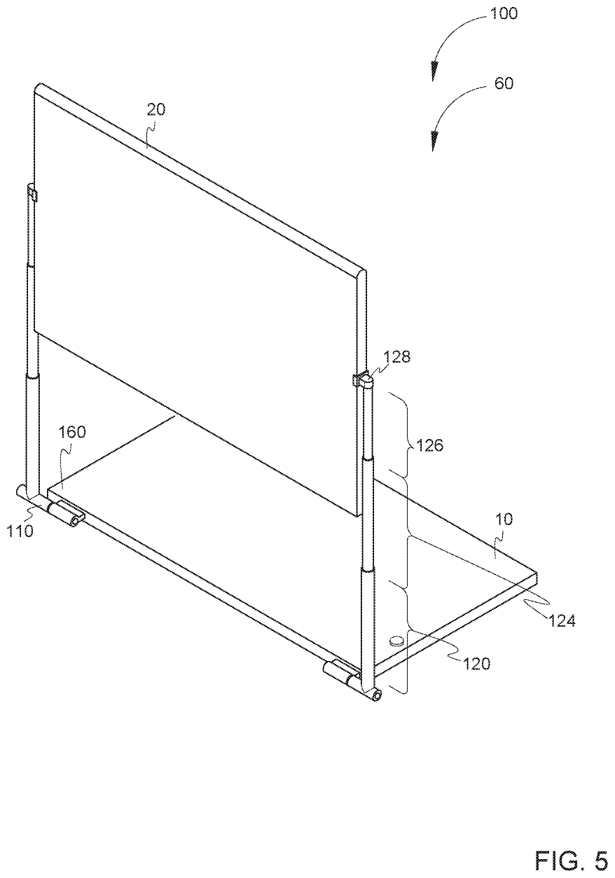

FIG. 5 is a perspective view of the laptop screen elevator 100 of FIG. 1 during an elevated condition 60, according to an embodiment of the present disclosure. As shown, at least one cantilever 120 comprises at least one telescoping member 124 and 126 connecting at least one screen-mount 130 to at least one cantilever 120, such that at least one telescoping members 124 and 126 together may telescope within the at least one cantilever 120. At least one cantilever 120 may include a first-cantilever 170 and a second-cantilever 180, such that the screen-assembly 20 is disposed between first-cantilever 170 and second-cantilever 180. At least one screen mount 130 may include a releasable claw 128 able to clamp upon the screen-assembly 20.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A laptop screen elevator able to adjust a distance between a laptop-chassis and a screen-assembly, the laptop screen elevator comprising:
at least one cantilever;
at least one screen-mount able to rigidly affix to the screen-assembly, the at least one screen-mount comprising a slot, the slot being dimensioned such that the at least one cantilever may slide within the slot;
at least one hinge pivotably connecting the at least one cantilever to the laptop-chassis.

2. The laptop screen elevator of claim 1, wherein
the at least one cantilever further comprises at least one toothed-rack; and
the at least one screen-mount further comprises at least one button able to engage with the toothed-rack in a resting position, and disengage with the toothed-rack when pressed into the at least one screen-mount.

3. The laptop screen elevator of claim 1, wherein the at least one button is spring-loaded.

4. The laptop screen elevator of claim 1, further comprising
a motor able to either elevate or de-elevate the at least one screen-mount relative to the at least one hinge by translating the at least one cantilever within the slot; and
an activator embedded into the laptop-chassis able to either advance or retard the motorizer.

5. The laptop screen elevator of claim 4, further comprising a linkage connecting the motor to the at least one rod.

6. The laptop screen elevator of claim 1, wherein the at least one cantilever comprises at least one telescoping member connecting the at least one screen-mount to the at least one cantilever, such that the at least one rod and the at least one telescoping member, together may telescope within the at least one cantilever.

7. The laptop screen elevator of claim 1, wherein the at least one cantilever comprises a first-cantilever and a second-cantilever, such that the screen-assembly is disposed between the first-cantilever and the second-cantilever.

8. The laptop screen elevator of claim 1, wherein each of the at least one screen mount comprises a releasable claw able to clamp upon the screen-assembly.

9. The laptop screen elevator of claim 1, wherein each of the at least one hinge, the at least one cantilever, and the at least one screen-mount further contain cavities able to contain wires passing from the laptop-chassis to the screen-mount.

10. A laptop screen elevator able to adjust a distance between a laptop-chassis and a screen-assembly, the laptop screen elevator comprising:
a cantilever;
a screen-mount able to rigidly affix to the screen-assembly, the screen-mount comprising a slot, the slot being dimensioned such that the cantilever may slide within the slot;
a hinge pivotably connecting the cantilever to the laptop-chassis; and
two buttons disposed within the screen-mount, each button being able to engage with the cantilever in a resting position, and disengage with the cantilever when pressed into the at least one screen-mount.
